(19) United States
(12) Patent Application Publication
(10) Pub. No.: US 2015/0115503 A1
(43) Pub. Date: Apr. 30, 2015

(54) METHOD OF FABRICATION AND A MOLD FOR FABRICATING A GASKET OF SPIRAL SHAPE

(71) Applicant: Produits Plastiques Performants Holding - 3P Holding, Dardilly Cedex (FR)

(72) Inventor: Bruno Agnus, Chamarandes Choignes (FR)

(21) Appl. No.: 14/340,974

(22) Filed: Jul. 25, 2014

(30) Foreign Application Priority Data
Oct. 24, 2013 (FR) 1360371

(51) Int. Cl. B29C 45/22; B29D 99/00

(52) U.S. Cl. CPC B29C 45/22; B29D 99/0053; B29K 2101/00
USPC 264/328.1; 425/573

(57) ABSTRACT

The invention relates to a mold for fabricating a spiral-shaped gasket made out of plastics material, the mold including at least one spiral-shaped cavity and, for the purpose of feeding molten plastics material, also including two distinct ingates, these ingates being arranged on the same face of a cavity.

### CROSS-REFERENCE TO RELATED APPLICATIONS

This application claims priority to French Application No. 1360371 filed Oct. 24, 2013, which is incorporated herein by reference and made a part hereof.

### BACKGROUND OF THE INVENTION

1. Field of the Invention

The present invention relates in general to the field of spiral compressors, and more particularly to fabricating spiral or “scroll” sealing segments for providing sealing in such compressors.

2. Description of the Related Art

Spiral compressors generally comprise a leaktight enclosure containing a stationary volute and a movable volute, each volute comprising an end plate from which there extends a spiral. The spirals of the stationary and movable volutes are engaged one in the other so as to define compression chambers of variable volume.

In order to seal the compressor chambers, two spiral-shaped sealing segments (one per volute) are arranged between the free end of each spiral and the end plate of the opposite volute. In general, a spiral-shaped groove is formed in the end of each volute spiral for the purpose of receiving the corresponding sealing segment, at least in part.

Spiral-shaped sealing segments, which are conventionally made of thermoplastic material, may be obtained by injection molding. The ratio of the fineness of the injected element to its length means that very great care needs to be applied to the injection molding method in order to optimize filling of the mold cavity.

Documents U.S. Pat. No. 6,126,422 and U.S. Pat. No. 6,270,713 disclose a spiral-shaped gasket and a plastics injection method enabling it to be obtained. The method of injection seeks to obtain satisfactory filling of the mold cavity, and it consists in injecting molten plastics material via two ingates into the cavity, which ingates are situated on one side of the cavity, each ingate being situated at a distance from one of the two ends of the spiral that corresponds to exactly one-fourth of the total length of the spiral. In accordance with that injection method, and as can be seen in the figures of the abstracts of the two aforementioned patents, the principle of providing two ingates situated on opposite faces of the mold cavity and at a distance from the nearer end of the spiral that is equal to one-fourth of the total length of the spiral enables the cavity to be filled in a satisfactory manner. Starting from each of the two ingates, that injection configuration generates two flows of material in opposite directions, giving four flows that are initially distinct, each of those four flows having exactly the same distance to travel inside the cavity (i.e. one-fourth of the total length of the cavity). That serves to minimize the distance that needs to be traveled by each flow, thereby avoiding the material cooling and solidifying prematurely.

What is needed, therefore, is a method for molding a mold that overcomes one or more of the problems in the prior art.

Nevertheless, the above-described method presents drawbacks. The two ingates are situated in opposite faces of the cavity so that the ingates are connected to a common feed source via a main injection channel (referred to as “sprue”) and two secondary injection channels. As in any injection method, the material contained in the injection channels (which are filled completely) is lost after cooling. In this respect, the configuration shown in the figures of the abstracts of the two above-mentioned patents would appear to be relatively favorable: the material that is lost, which corresponds to the volumes of the injection channels, is relatively small. However, in numerous configurations, the need for the two injection points both to be situated at the appropriate distance from the corresponding end of the cavity can lead to those ingates being spaced far apart from each other. FIG. 1 shows a spiral gasket as obtained at the end of the molding operation, that molded gasket being obtained in accordance with the teaching of the two above-mentioned patents. FIG. 1 thus shows a gasket 1 still attached to a sprue 2 and to two secondary injection channels 3 and 4. The injection points 5 and 6 are situated at the ends of the injection channels. In FIG. 1, it can be seen that the two injection points 5 and 6 are very far apart. This leads to providing a sprue and secondary injection channels of greatly increased volume, with the consequence of correspondingly increasing the amount of material that is lost in each molding operation. It can be seen that the quantity of material constituting the sprue 2 together with the injection channels 3 and 4 is very large compared with the quantity of material constituting the spiral gasket 1, once finished.

### SUMMARY OF THE INVENTION

The present invention seeks to remedy the above-described drawbacks of the prior art by proposing a mold and a method for fabricating a spiral gasket that enable the mold cavity to be filled in a satisfactory manner while minimizing the amount of material that is lost in each molding operation.

To this end, the present invention provides a mold for fabricating a spiral-shaped gasket made out of plastics material, the mold including at least one spiral-shaped cavity and, for the purpose of feeding molten plastics material, also including two distinct ingates, these ingates being arranged on the same face of the cavity.

Thus, the mold of the invention serves to optimize filling since at least two injection points are used. However, and above all, by using injection points that are situated on a common face, the size of the two sprues is greatly reduced compared with the prior art: the combined volume of the two sprues needed is less than the volume of the single sprue that would be necessary when performing a method in accordance with the prior art. Furthermore, the operations of cutting off the sprues are simplified compared with the prior art. The invention also presents the great advantage of enabling the injection points to be provided on the side face of the gasket that is the face less involved in providing the sealing function. Thus, any risk of leakage is greatly reduced with a gasket in accordance with the invention since the injection points (and the imperfections that they generate) are favorably situated on a face of the gasket that is not involved in providing sealing.

In an embodiment, the ingates are arranged on the outer face of the cavity.

In an embodiment, the ingates are arranged on the inner face of the cavity.

In an embodiment, the ingates are situated at a distance from respective ones of each of the ends of the cavity corresponding to one-fourth of the total length of the cavity.

In an embodiment, the mold has three distinct ingates.

In an embodiment, the mold has four distinct ingates.

In an embodiment, the mold includes one or more recesses communicating with the cavity, each recess being for filling with molten plastics material in order to constitute a riser.

In an embodiment, the mold has three recesses, two recesses arranged at the ends of the cavity and one recess arranged at equal distances from the two ends of the cavity.

In an embodiment, the ingates are set back from the face of the cavity on which they are arranged.

The invention also provides a method of fabricating a spiral-shaped gasket made of molded plastics material, the method comprising the step of injecting plastics material into a spiral-shaped cavity of a mold via at least two distinct ingates, these ingates being arranged on a common face of the cavity.

In an implementation, the method uses two ingates each situated at a distance from a corresponding one of the ends of the cavity that is equal to one-fourth of the total length of the cavity.

### BRIEF DESCRIPTION OF THE ACCOMPANYING DRAWINGS

The invention can be better understood on reading the following description given purely by way of example and made with reference to the accompanying drawings, in which:

FIG. 1 shows a prior art spiral gasket, as obtained at the end of the molding step;

FIG. 2 shows a spiral gasket in accordance with the invention, as obtained at the end of the molding step;

FIG. 3 shows a variant of the FIG. 2 spiral gasket;

FIG. 4 shows a spiral gasket in accordance with FIG. 2 or 3, as obtained after finishing operations; and

FIG. 5 shows a spiral gasket in accordance with one embodiment.

### DETAILED DESCRIPTION OF THE PREFERRED EMBODIMENTS

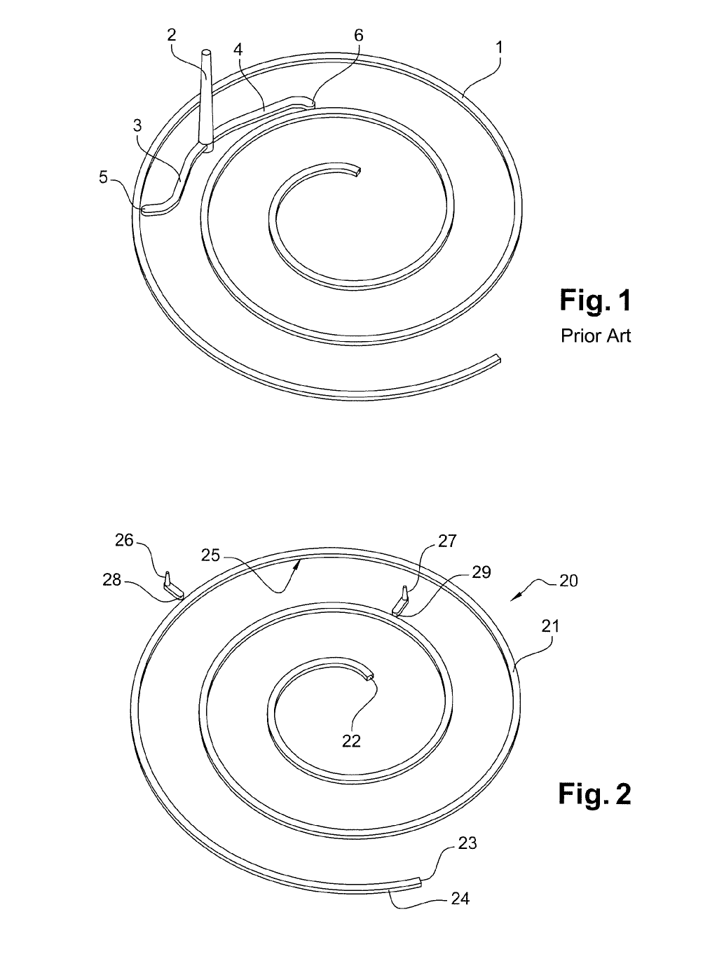

FIG. 1, as described above, shows a prior art spiral gasket.

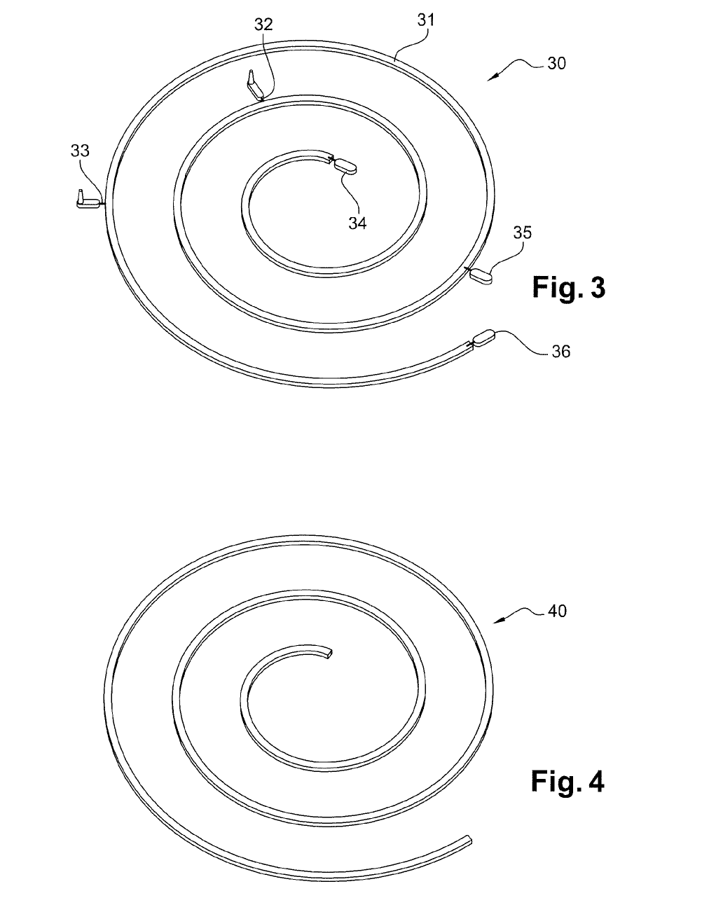

FIG. 2 shows a spiral gasket 20 in accordance with the invention, as obtained at the end of the molding operations and before the finishing operations (deburring, etc.).

The gasket 20 comprises a body 21 of spiral shape with two ends 22 and 23. In the example shown, the body 21 is of rectangular section and has an outer side face 24 and an inner side face 25. Two sprues 26 and 27 are present on the outer side face 24, each sprue 26, 27 being arranged at the location of one of two injection points 28, 29. In FIG. 2, it can be seen that the size of the sprues and the volume of the injection channels are very small: the amount of material lost on each molding operation is thus very small, and considerably smaller than in the prior art shown in FIG. 1. In addition, it can be seen that the gasket in the FIG. 2 example provides sealing for the compressor in which it is associated mainly via its outer side face 24, with the opposite side face being used little or not at all for sealing purposes. Thus, by arranging the injection points on the side face that is not involved in sealing, it is ensured that it is this side face that has the surface imperfections that remain at the injection points. Any risk of leakage is thus greatly reduced in a gasket in accordance with the invention.

In one embodiment, each of the injection points 28 and 29 is situated at a distance from the nearer end 22, 23 of the spiral that is equal to one-fourth of the total length of the spiral. Thus, during the molding operation, the injection of molten plastic material via the two injection points 28, 29 generates four fronts of material, with each of the fronts of material traveling along an identical distance in the mold cavity.

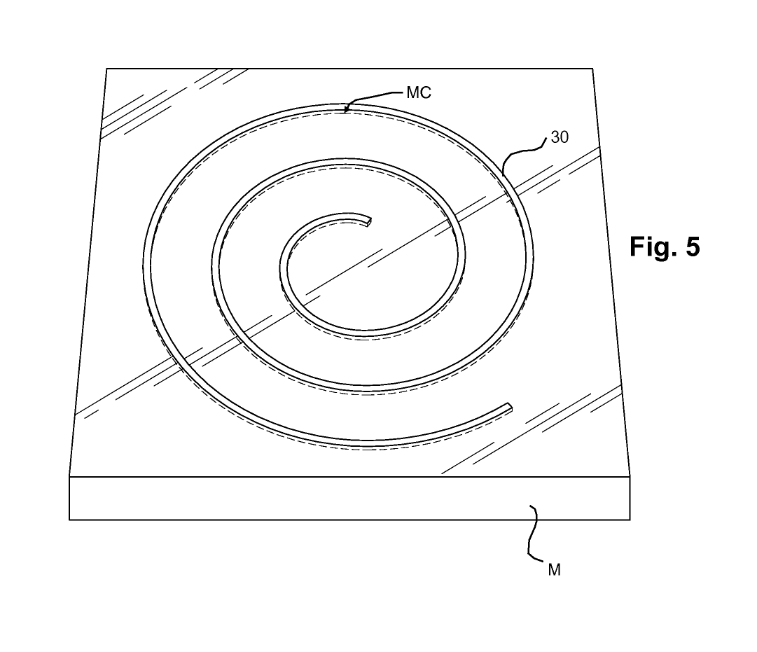

FIG. 3 shows a spiral gasket 30 in accordance with the invention, as obtained at the end of the molding operations and before the finishing operations. In order to mold the gasket 30, and as for the gasket of FIG. 2, use is made of two injection points 32, 33 that are arranged on the same face of the body 31 of the gasket 30. The mold M (as viewed in FIG. 5) used for obtaining the gasket 30 has one or more recesses suitable for receiving excess material in order to improve the filling of the mold cavity MC. For ease of illustration, the mold cavity MC illustrates the gasket 30 in the mold cavity MC. These recesses appear in the form of risers 34, 35, 36 on the molded gasket 30. In the example described, a riser 34, 36 is provided at each of the ends of the body 31 of the gasket 30 and another feeder 35 is provided at the middle of the body 31. These risers serve as vents and as burn traps, and as mentioned above, they serve to optimize filling of the mold cavity. Advantageously, the riser 35 that is arranged at equal distances from the ends of the body 31 in the example shown is arranged on the outer side face of the body 31.

FIG. 4 shows a gasket 40 in accordance with the invention after the finishing operations. FIG. 5 shows a mold M for making the gasket 30 in accordance with one embodiment.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A mold for fabricating a spiral-shaped gasket made out of plastics material, the mold including at least one spiral-shaped cavity and, for the purpose of feeding molten plastics material, also including two distinct ingates, these ingates being arranged on a same face of the cavity.

2. The mold according to claim 1, wherein the ingates are arranged on an outer face of the cavity.

3. The mold according to claim 1, wherein the ingates are arranged on an inner face of the cavity.

4. The mold according to any preceding claim 1, wherein the ingates are situated at a distance from respective ones of each of the ends of the cavity corresponding to one-fourth of the total length of the cavity.

5. The mold according to claim 1, having three distinct ingates.

6. The mold according to claim having four distinct ingates.

7. The mold according to claim 1, wherein the mold includes one or more recesses communicating with the cavity, each recess being for filling with molten plastics material in order to constitute a riser.

8. The mold according to claim 7, wherein the mold has three recesses, two recesses arranged at the ends of the cavity and one recess arranged at equal distances from the two ends of the cavity.

9. The mold according to claim 1, wherein the ingates are set back from the face of the cavity on which they are arranged.

10. A method of fabricating a spiral-shaped gasket made of molded plastics material, the method comprising the step of injecting plastics material into the spiral-shaped cavity of a mold via at least two distinct ingates, these ingates being arranged on a common face of the cavity.

11. The method according to claim 10, using two ingates each situated at a distance from a corresponding one of the ends of the cavity that is equal to one-fourth of the total length of the cavity.

12. The mold according to claim 2, wherein the ingates are situated at a distance from respective ones of each of the ends of the cavity corresponding to one-fourth of the total length of the cavity.

13. The mold according to claim 3, wherein the ingates are situated at a distance from respective ones of each of the ends of the cavity corresponding to one-fourth of the total length of the cavity.

14. The mold according to claim 2, having three distinct ingates.

15. The mold according to claim 3, having three distinct ingates.

16. The mold according to claim 2, having four distinct ingates.

17. The mold according to claim 3, having four distinct ingates.

18. The mold according to claim 2, wherein the mold includes one or more recesses communicating with the cavity, each recess being for filling with molten plastics material in order to constitute a riser.
